(19) United States
(12) Patent Application Publication
(10) Pub. No.: US 2024/0386099 A1
(43) Pub. Date: Nov. 21, 2024

(54) SECURITY RISK MANAGEMENT ENGINE IN A SECURITY MANAGEMENT SYSTEM

(71) Applicant: Microsoft Technology Licensing, LLC, Redmons, WA (US)

(72) Inventors: Josef WEIZMAN, Haifa (IL); Yaron David Fruchtmann, Herzliya (IL); Ram Haim Pliskin, Rishon Lezion (IL)

(21) Appl. No.: 18/320,105

(22) Filed: May 18, 2023

(51) Int. Cl. G06F 21/55; G06F 21/57

(52) U.S. Cl. CPC G06F 21/554; G06F 21/577; G06F 2221/033

(57) ABSTRACT

Methods, systems, and computer storage media for providing security risk management using a security risk management engine in a security management system. The security risk management engine operates to provide security risk management based on a contextual security matrix that uses contextual information of a security issue to quantify a security exposure of the security issue. In operation, a security issue identifier for a security issue associated with a computing environment computing device is accessed. Contextual information associated with the security issue is identified. Using a contextual security matrix (CSM), a CSM-based risk score that quantifies a security exposure associated with the security issue is generated. Based on the CSM-based risk score, a security posture visualization associated with the computing environment is generated. The security posture visualization comprises the security issue having the CSM-based risk score. The security posture visualization is communicated to cause display of the security posture visualization.

Users rely on computing environments with applications and services to accomplish computing tasks. Distributed computing systems host and support different types of applications and services in managed computing environments. In particular, computing environments can implement a security management system that provides security posture management functionality and supports threat protection in the computing environments. For example, cloud security posture management (CSPM) and enterprise security posture management can include the following: identifying and remediating risk by automating visibility, executing uninterrupted monitoring and threat detection, and providing remediation workflows to search for misconfigurations across diverse cloud computing environments and infrastructure.

### SUMMARY

Various aspects of the technology described herein are generally directed to systems, methods, and computer storage media for, among other things, providing security risk management using a security risk management engine of a security management system. Security risk management supports management of security risk associated with security aspects of resources and workloads in computing environments including both calculating security risk and prioritizing security issues. The security risk management engine operates to provide security risk management based on a contextual security matrix that uses contextual information of a security issue to quantify a security exposure (e.g., exploitability and impact) of the security issue. For example, a security administrator can request to view security issues of their computing environment, and the security issues are provided based on security risk management operations that process contextual information of the security issues using a contextual security matrix, calculate security risk scores for the security issues, and prioritize the security issues using different types of security scores (e.g., base-score, contextual scores, and contextual security matrix-based risk scores).

Conventionally, security management systems are not configured with a comprehensive computing logic and infrastructure to efficiently provide adequate security risk management. For example, security issues, security alerts and remediation workflows for a computing environment can be continuously identified, generated and provided as security posture information—without sufficient security exposure analysis and prioritization—because the security management system lacks integration with security risk management operations.

Merely identifying security issues and providing security posture information—without additional security exposure analysis and prioritization of security issues in security posture information—causes deficient functioning of the security management system. For example, a deficient security posture interface does not adequately present the security posture information in a manner that efficiently summarizes the security posture of a computing environment. Moreover, without adequate security exposure analysis and prioritization of security issues—such as security issue tasks—in security posture information, high impact threats are not expediently addressed and potential threats can become actual threats which can lead to unauthorized access to data in the computing environment and malicious operations in the computing environment.

A technical solution—to the limitations of conventional security management systems—can include the challenge of providing a contextual security matrix, context-based security exposure analysis, and prioritization of security issues and security issue tasks based on different types of security scores—along with providing security risk management operations and interfaces via a security risk management engine in a security management system. As such, the security management system can be improved based on security risk management operations in the security management system that operate to effectively summarize and provide security posture information of a computing environment in a particular manner.

In operation, a security issue identifier of a security issue associated with a computing device in a computing environment, is accessed. Contextual information associated with the security issue is identified. Contextual information comprises a computing environment configuration or state that affects a security exposure of the security issue on the computing environment. Using a contextual security matrix (CSM), a CSM-based risk score that quantifies the security exposure associated with the security issue is generated. The CSM is defined using a contextual security matrix model that supports generating CSM-based risk scores using base-scores and contextual scores of instances of contextual information. Based on the CSM-based risk score, a security posture visualization associated with the computing environment is generated. The security posture visualization comprises the security issue identifier associated with the CSM-based risk score. The security posture visualization can include security issues that are prioritized for display, where prioritization of the security issues is based on primary prioritization operations, secondary prioritization operations, and refinement operations that generate primary scores, secondary scores, and final secondary scores, respectively, for prioritization.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary security management system including a security risk management engine, in accordance with aspects of the technology described herein;

FIG. 2A is a block diagram of an exemplary security management system including security risk management engine, in accordance with aspects of the technology described herein;

FIG. 2B is a block diagram of an exemplary security management system including a security risk management engine, in accordance with aspects of the technology described herein;

FIG. 3 provides a first exemplary method of providing security risk management using a security risk management engine, in accordance with aspects of the technology described herein;

FIG. 4 provides a second exemplary method of providing security risk management using a security risk management engine, in accordance with aspects of the technology described herein;

FIG. 5 provides a third exemplary method of providing security risk management using a security risk management engine, in accordance with aspects of the technology described herein;

FIG. 6 provides a third exemplary method of providing security risk management using a security risk management engine, in accordance with aspects of the technology described herein;

FIG. 7 provides a third exemplary method of providing security risk management using a security risk management engine, in accordance with aspects of the technology described herein;

FIG. 8 provides a third exemplary method of providing security risk management using a security risk management engine, in accordance with aspects of the technology described herein;

FIG. 9 provides a block diagram of an exemplary distributed computing environment suitable for use in implementing aspects of the technology described herein; and

FIG. 10 is a block diagram of an exemplary computing environment suitable for use in implementing aspects of the technology described herein.

### DETAILED DESCRIPTION

### Overview

A security management system supports management of security aspects of resources and workloads in computing environments. The security management system can help enable protection against threats, help reduce risk across different types of computing environments, and help strengthen a security posture of computing environments (i.e., security status and remediation action recommendations for computing resources including networks and devices). For example, the security management system can provide real-time security alerts, centralize insights for different resources, and provide for preventative protection, post-breach detection, and automated investigation, and response.

Conventionally, security management systems are not configured with a comprehensive computing logic and infrastructure to efficiently provide adequate security risk management. For example, security issues, security alerts and remediation actions for a computing environment can be continuously identified, generated and provided as security posture information—without suitable sufficient security exposure analysis (e.g., exploitability and impact) and prioritization—because the security management system lacks integration with security risk management operations. And, the total number of potential threats (or actuals threats) of a cloud computing system can be prohibitively high and become compute-intensive to manage through brute-force methods that include systematically enumerating all possible potential threats.

In addition, without adequate security exposure analysis and prioritization of security issues in security posture information, high impact threats are not expediently addressed and potential threats can become actual threats which can lead to unauthorized access to data in the computing environment and malicious operations in the computing environment. Moreover, merely identifying security issues and providing security posture information causes deficient functioning of the security management system. A deficient security posture interface does not adequately present the security posture information in a manner that efficiently encapsulates the security posture of a computing environment. As such, a more comprehensive security management system—with an alternative basis for performing security management operations—can improve computing operations and interfaces in security management systems.

Embodiments of the present technical solution are directed to systems, methods, and computer storage media for, among other things, providing security risk management using a security risk management engine of a security management system. Security risk management supports management of security risk associated with security aspects of resources and workloads in computing environments including calculating security risk and prioritizing security issues. Security risk management is provided using the security risk management engine that is operationally integrated into the security management system. The security management system supports a contextual security matrix framework of computing components associated with processing contextual information calculating security risk scores and prioritizing security issues computing environment.

The security risk management engine operates to provide security risk management based on a contextual security matrix that uses contextual information of a security issue to quantify a security exposure (e.g., exploitability and impact) of the security issue. For example, a security administrator can request to view security issues of their computing environment, and the security issues are provided based on security risk management operations that process contextual information of the security issues using a contextual security matrix, calculate security risk scores for the security issues, and prioritize the security issues using different types of security scores (e.g., base-score, contextual scores, and contextual security matrix-based risk scores).

At a high level, the security management system supports security risk management operations that provide security posture information for a computing environment based on unsecured credentials in the computing environment. By way of context, security posture management can include identifying a large number of security issues and recommended remediation actions (e.g., security issue tasks) for different types of computing devices (e.g., hardware devices or software devices). In particular, a security risk management engine—that provides the security risk management operations—is provided, the security risk management engine supports a contextual security matrix that is used to manage (e.g., score and prioritize) security issues based on their context, and the contextual security matrix—along with security task prioritization engine—can be used to prioritize security issues tasks (i.e., recommended remediation actions for contextual security issues).

The security risk management operations can specifically be performed based on a contextual security matrix framework. The contextual security matrix defines how each security issue is affected by each contextual information (e.g., an instance of contextual information), where a security issue can refer to a computer environment configuration or state that might pose a security risk. For example, a security issue can include a software vulnerability, exposure to the internet, or an excessive permission to a resource. Several different recommended remediation actions can be mapped to a single security issue. For example, a first recommended remediation action can be “close open management port on a VM” and a second recommended remediation action can be “restrict internet access to cloud storage”—where both the first recommended remediation action and the second remediation action are mapped to the same security issue (e.g., wide exposure to the internet). A recommended remediation action can specifically refer to security issue task, where the recommended remediation action is for a security issue (e.g., a contextual security issue item) that includes contextual information. It is also contemplated that recommended remediation action and security issue task are used interchangeably herein.

Contextual information can refer to a computing environment configuration or state that affects the security exposure created by the security issue. For example, a first instance of contextual information can be “critical asset”—that is contextual information that affects the risk evaluation of various security issues (e.g., software vulnerability) and the corresponding potential impact. A second instance of contextual information can be “contains sensitive data”—that is contextual information that affects the risk evaluation of various security issues (e.g., excessive permissions) and the corresponding potential exploitability. Contextual information can be used to score and prioritize security issues associated with different instances of contextual information.

Contextual information can impact each security issue differently. In particular, the importance of the contextual information differs between the various security issues. For example, a first instance of contextual information “wide exposure to the internet” can have a significant effect of on the issue of “software vulnerability” because of a likelihood of exploitation. However, the first instance of the contextual information “wide exposure to the internet”, may have a lower effect on the security issue “resource with privileged configuration” because of reduced impact of the security issue.

By way of example, the contextual score can be based on potential impact and/or exploitability of the security issue in combination with the contextual information. Potential impact can refer to the potential harm that could result if the security issue is successfully exploited by an attacker. This includes the potential impact on the confidentiality, integrity, and availability of the affected system or data. For example, a security issue that could allow an attacker to steal sensitive data or disrupt critical services would have a high potential impact.

Exploitability can refer to the likelihood that an attacker will be able to successfully exploit the security issue. This includes factors such as the level of skill and resources required to exploit the security issue, the availability of exploit code or tools, and the level of complexity involved in exploiting the security issue. For example, a security issue that requires advanced technical skills and knowledge to exploit would have a lower exploitability than one that can be easily exploited with simple tools or techniques.

The effect of each instance of contextual information on each security issue can be expressed in the contextual security matrix. Each security issue can be associated with a security issue base-score which represents a defined score for the security issue. The base score may be a numerical value assigned to the security issue based on a severity of the security issue. The base score can be used as a starting point for evaluating the severity of the security issue, where the security issue further analyzed for an overall risk using contextual information for the security issue. A security issue can be associated with a plurality of instances of contextual information. Each instance of contextual information can be associated with a contextual score.

The contextual security matrix can support calculations for a CSM-based risk score associated with a security issue base-score and contextual scores for one or more instances of contextual information. For example, the CSM-based risk score can be generated based on a sum of a security base-score of the security issue and the contextual scores of one or more contextual scores of instances of contextual information of the security issue. The CSM-based risk score can refer to an environment-specific score and function as a prioritization score for presenting security issues and security posture information for a computing environment. In this way, the contextual security matrix operates as a data structure to address issues associated with inadequate prioritization (e.g., security alert overload and recommendation fatigue) of security issues and their corresponding recommendation remediation actions. Other variations and combinations of generating a CSM-based risk score using security issue base-scores and contextual scores for one or more instances of contextual information are contemplated with embodiment described herein.

The contextual security matrix can support generating CSM-based risk scores for different types of potential threats and actual threats exist, for example, use of proxies to gain access to a computing environment or unauthorized running of crypto mining software in a computing environment. An attack on a cloud computing environment—for example, performed by a malicious actor—can include several attack operations that are executed to gain access to resources on the cloud computing environment. The attack operations can trigger alerts, when the security system is configured to monitor for these types of attack operations. If multiple attack operations are identified—and a determination that the attack operations are related is made—the alerts associated with the attack operations can be defined as a security incident. The security incident can refer to a collection of correlated alerts and corresponding security data that make up a story of an attack. The attack story can be associated with a security graph and an attack path definition that identifies attack objects (e.g., attack operations, compromised resources, file locations and file types). The attack path definition can describe how an attacker gained access to a computing environment and related operations and computing resources associated with the attack and unauthorized access. A security incident can advantageously combine multiple alerts associated with a single attack to support managing and responding to the security incident.

The attack story can be associated with a security graph and an attack path definition that identifies attack objects (e.g., attack operations, compromised resources, file locations and file types). The attack path definition can describe how an attacker gained access to a computing environment and related operations and computing resources associated with the attack and unauthorized access. An attack path analysis—using a graph—based algorithm—scans a cloud security graph to identify exploitable paths that attackers may use to breach a computing environment. The attack path analysis exposes attack paths and suggests remediation actions for issues that would break the attack path and prevent a successful breach.

The security risk management engine further provides security risk management operations that support dynamic prioritization of security issues. In particular, the security issues associated with the contextual security matrix can be referred to as contextual security issue (CSI) items that represent a security issue in a computing environment, where a contextual security issue item is a security issue that is enriched with contextual information. For example, a security issue may be a software vulnerability or a misconfiguration in the computing environment, and a contextual security issue item can be generated for the software vulnerability or the misconfiguration, where the contextual security issue items further includes security contextual information (e.g., “critical asset” or contains “sensitive data”). A security issue record can include security issue identifiers, base-score, contextual information, contextual scores, security issues tasks, CSM-based scores, and prioritization scores (e.g., primary scores, secondary scores, and final secondary scores).

As discussed, security issues are can be associated with security issue tasks or recommended remediation actions, where a security issue task is an actionable item that can be performed to mitigate the security issue (e.g., “install software update to patch vulnerable software). The security issue “software vulnerability” may also be associated additional security issue tasks including “update firewalls and intrusion detection” or “update system configuration.” In this way, a single security issue may have multiple security issues tasks or recommended remediation actions.

Security issues can also be associated with a security issue type, where the security issue type is a category associated with a security issue to identify, distinguish, and report on security issues. For example, security issue types can include malware, cloud security, phishing, ransomware, SQL injection, Man-in-the-middle (MITM), cross-site scripting (XSS), social engineering, data loss, password attacks, insider threats, denial of service (DDoS), and network vulnerabilities.

The security risk management engine can implement an algorithm that performs operations to prioritize CSI items according to their overall quantified risk. The security risk management engine implements the algorithm based on a primary prioritization operation and a secondary prioritization operation. The primary prioritization operation includes calculating contextual scores for security issue tasks of a security issue, the contextual scores are calculated using a contextual security matrix (CSM). The highest contextual score (or contextual score and base-score) is identified and designated as a primary score for the security issue.

As discussed, different contextual information can impact a security issue differently. For example, a first security issue (i.e., vulnerability) can have a base-score of 5, with a first instance of contextual information (e.g., exposure to the internet) having a contextual score of 8, for a total contextual score of 13; and the first security issue (i.e., vulnerability) can have the base-score of 5, with a second instance of contextual information (e.g., resource with privileged configuration) having a contextual score of 3, for a total contextual score of 8. The highest total contextual score (i.e., 13) is identified and designated as a primary score for the security issue. The security issue record can further include security tasks associated with the security issues—in combination with the contextual information and contextual score. As such, a security issue can be mapped to a security issue task, where the security issue task is prioritized based on the security issue record.

Based on a primary score, the plurality of security issues and their corresponding security issue tasks are grouped into different primary groups. In operation, the security issue tasks are first be grouped by security issue type and then by primary score. The primary groups are subsequently prioritized according to their shared primary score. By way of illustration, primary group 1 can have security issue type: vulnerability; and score: 13 (i.e., containing all the issues of type: vulnerability and score 13). Primary group 2 can have security issue type: excessive permission; and score: 13 (i.e., containing all the issues of type: Excessive permissions and score 13). Primary group 3 can have security issue type: vulnerability; and score 8 (i.e., containing all the issues of type: vulnerability and score 8).

The secondary prioritization operation includes prioritizing security issue tasks within each primary group. The priority groups each have a plurality of security issues and contextual scores and corresponding security issues tasks. The contextual scores can be sorted. In particular, the contextual scores can be sorted in descending order. In this way, the security issue task with the highest un-matching score is prioritized. For example, consider the following security issue tasks and contextual scores: Task-1 contextual scores: [11, 11, 9]; Task-2 contextual scores: [11, 11, 9, 8]; and Task-3 contextual score: [11, 9, 9, 8, 8, 8]. Task-1 and Task-2 precede Task-3 because the first un-matching item in their contextual scores has a higher value (i.e., 11 compared to 9).

The security risk management engine can further provide additional fine-tuned secondary prioritization, where the secondary prioritization includes sorting based on performing contextual score refinement operations on the contextual scores. For example, a first security issue task and a second security issue task may—via primary prioritization and secondary prioritization operations still have the same score. In particular, a first security issues with a first VM having a software vulnerability; and a second security issue with a first VM having a software vulnerability. The secondary prioritization using contextual scores may compute the same scores for the first issues and the second issue.

In such situations, contextual information can be represented as graph nodes and edges. For example, an instance of contextual information for the security issue “software vulnerability” can be “wide exposure to the internet,” where a vulnerable virtual machine (VM) associated with the software vulnerability is exposed to the internet. A VM with a software vulnerability, where the VM is further exposed to the internet can be categorized as a high or severity security issue. In this case, the context of the security issue is represented by an edge (network connectivity) between two nodes (a) internet; and (b) VM. Various context can be represented by different edges. And, for each edge, a decay factor is assigned, representing a quantified difficulty to traverse the edge. For example, a decay factor can be based on historical attack path information and attack path analysis that supports representing a likelihood of a first issue being exploited or a second being exploited as a function of a decay factor.

Each CSI item in the list of contextual issues is compared to its basic form, and for each additional edge, the contextual score is adjusted. In particular, the contextual score can be adjusted by multiplying the contextual score by the edge's decay factor. For example, a basic form of “exposed vulnerable VM has access to resource” is scored X, and account for a single “has access” edge between the VM and the resource. If the access in a CSI item is achieved via a longer path, through an additional node and an additional “has access” edge, then the score is multiplied by the decay factor of the “has access” edge. For example, df*X. The refined contextual scores are then summed to generate a final secondary score. The security risk management engine may consider Task-1 [0.9*11, 0.3*11, 9] and the final secondary score is generated as (0.9*11+0.3*11+9)=22.2. Tasks are subsequently prioritized based on the final secondary score. In particular, the final secondary scores can be sorted in descending order.

The security posture information can be generated based on the security scores (e.g., CSM-based risk score, primary scores, secondary scores, and final secondary scores) such that security posture information is prioritized and filtered based on the risk score. A prioritization identifier (e.g., high, medium, low) can be provided in the security posture visualization in combination with an alert associated with a security issue. Alternatively, a notification associated with the security risk management information, security risk prioritization information or the alert can be communicated. Other variations and combinations of communications associated with the unsecured credential are contemplated with embodiments described herein.

Advantageously, the embodiments of the present technical solution include several inventive features (e.g., operations, systems, engines, and components) associated with a security management system having a security risk management engine. The security risk management engine supports security risk management operations that include providing a contextual security matrix, context-based security exposure analysis, and prioritization of security issues and security issue tasks based on different types of security scores—along with providing security risk management operations and interfaces via a security risk management engine in a security management system. The security risk management operations are a solution to a specific problem (e.g., limitations in additional contextual information and prioritization of security issues in security posture information) in security management. The contextual security matrix provides a data structure for storing and retrieving security issue records and security information (e.g., base-scores, contextual scores, and CSM-based risk scores) in a way that improves computing operations in a security management system. Moreover, large amounts of security information that is stored for a cloud computing system can be summarized and presented in a particular manner to improve user interfaces of the security management system.

### Example Systems and Operations

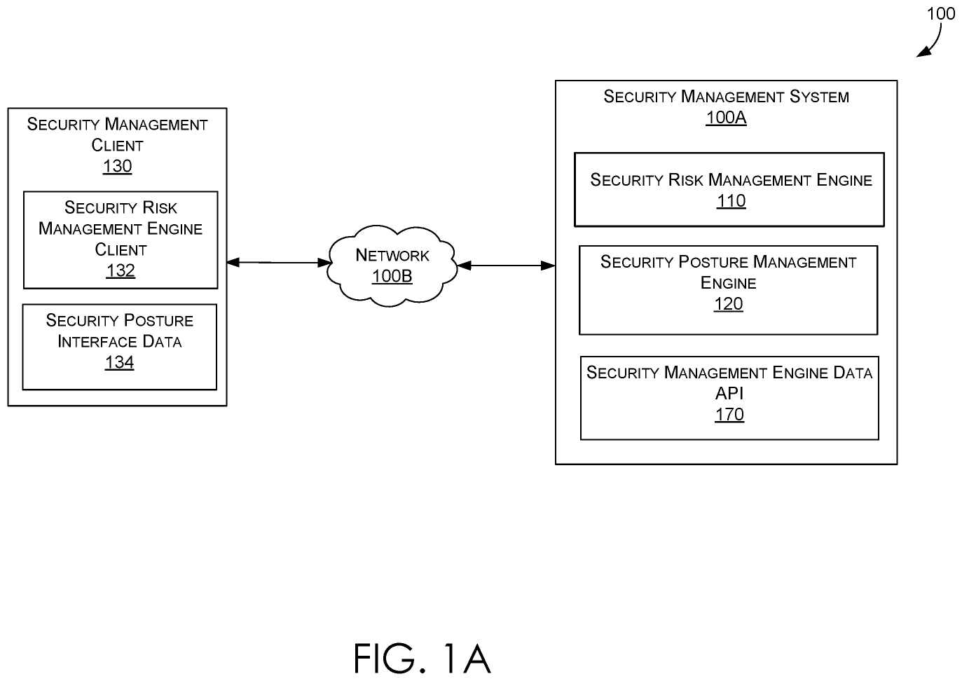

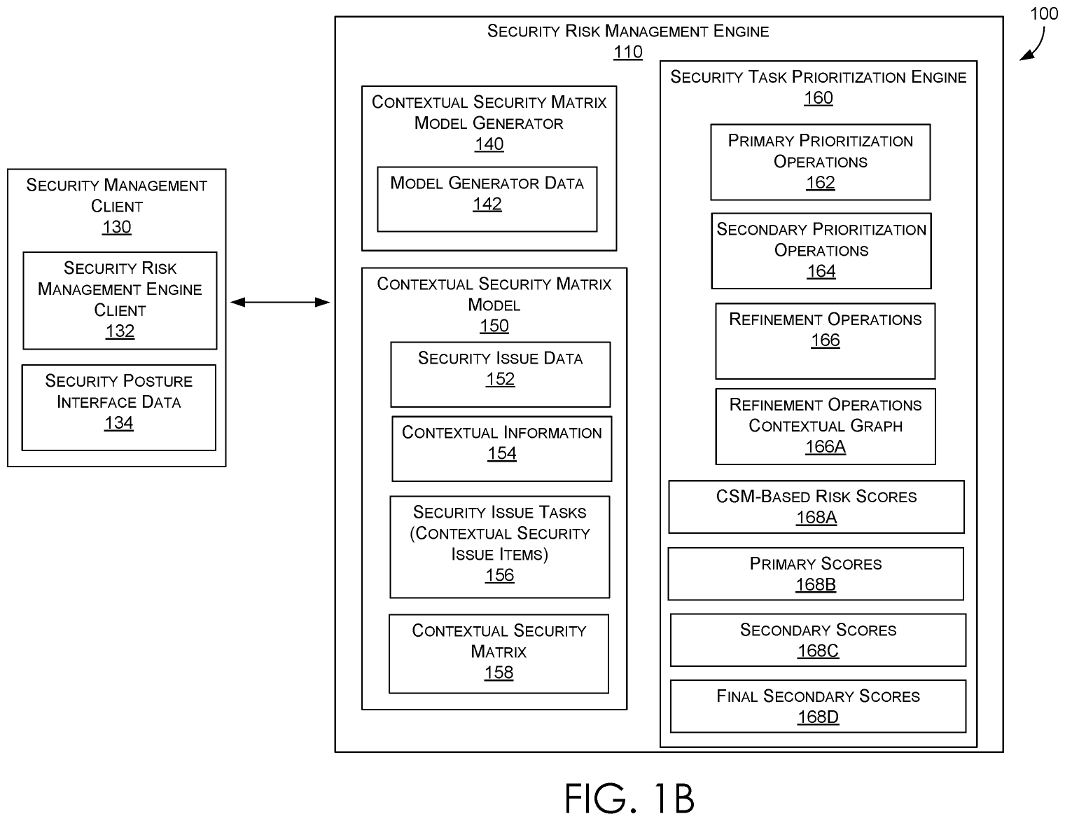

Aspects of the technical solution can be described by way of examples and with reference to FIGS. 1A and 1B. FIG. 1A illustrates a cloud computing environment (system) 100 and security management system 100A. The security management system 100A includes network 110B, security risk management engine 110, security posture management engine 120, security management engine data API 170, and security management client 130 with security risk management engine client 132 and security posture interface data 134.

The cloud computing environment 100 provides computing system resources for different types of managed computing environments. For example, the cloud computing platform that supports delivery of computing services—including servers, storage, databases, networking, and intelligence. A plurality of security management clients (e.g., security management client 130) include hardware or software that access resources in the cloud computing environment 100. Security management client 130 can include an application that supports client-side functionality associated with cloud computing environment. The plurality of security management clients can access computing components of the cloud computing environment 100 via a network (e.g., network 100B) to perform computing operations.

The security management system 100A is designed to provide security risk management using the security risk management engine 110. The security management system 100A provides an integrated operating environment based on a security management framework—including a contextual security matrix framework—of computing components associated with processing contextual information, calculating security risk scores and prioritizing security issues in a computing environment. The security management system 100A integrates security risk management operations—that provide security risk management based on a contextual security matrix that uses contextual information of a security issue to quantify a security exposure (e.g., exploitability and impact) of the security issue—into security management operations and interfaces to effectively provide security posture information and remediation information. For example, a security administrator can request a security posture of their computing environment, and the security posture—including security issues prioritized based on CSM-based risk scores—is provided based on security risk management operations via the security management client 130.

The security risk management engine 110 is also responsible for providing security risk management based on security risk management operations. The security risk management engine 110 operates with security management system components (e.g., security posture management engine 120 and security management engine data API 170) to provide security posture management. The security posture management engine 120 operates to provide visibility to security status of resources in a computing environment. The security posture can be associated with network, data, and identity resources of a computing environment.

The security posture management engine 120 can further support generating security posture visualizations based on the security posture information including CSM-based risk scores. The security posture visualization may be a graphical user interface that includes graphical objects associated with security posture information. The security posture information can specifically include security issues (e.g., security issue identifiers) having contextual information, where the contextual information is used in generating their corresponding CSM-based scores. The security issues can be generated as alerts that are prioritized for presentation or display based on their CSM-based risk scores. For example, a security posture visualization can prioritize of different alerts based at least on part CSM-based risk score, where the contextual information of the security issue associated with the alert is also included in the security posture visualization. The security posture visualization can include security issue tasks that are prioritized for display, where prioritization of the security issue tasks is based on a primary prioritization operation, a secondary prioritization operation, and a refinement operation that generate primary scores, secondary scores, and final secondary scores, respectively, for prioritization.

The security posture visualization can further include security issues tasks that are recommended remediation actions associated different alerts—including alerts that are associated with the security issue. Advantageously, a recommended remediation action associated with a properly prioritized alert—provided in combination with corresponding contextual information—can be selected and communicated to cause the recommended remediation action to be performed. The remediation action can address an actual threat or potential threat associated with the alert. For example, a recommended remediation action can include off-boarding a computing device, disabling a user, quarantining a file; turning off external email, or running an antivirus scan. Other variations and combinations of security posture visualizations with recommended remediation actions are contemplated with embodiments described herein.

The security management system 100A includes a security management engine data Application Programming Interface (API) 170. The security management engine data API 170 can support accessing different types of data and data management functions of the security management system 100A and the cloud computing environment 100. For example the cloud computing environment 100 may support a security graph (e.g., MICROSOFT's Intelligent Security Graph) that provides telemetry data associated with a plurality of resources in a computing environment. The security graph may implement machine learning to generate actionable security alerts and recommendations for security issues. The security graph can be associated security management engine data API 170 and operate as an intermediary service to access a shared schema of aggregated security information from a plurality of security providers in a computing environment. In this way, the security graph and the security management engine data API 170 can support integrating security information or security data from different security providers via an API connector that streams alerts to a security management system.

Security information that is accessible via the security management engine data API 170 can include additional data from informational databases in a computing environment. For example, a cloud computing provider can maintain additional data in different types of databases (e.g., active directory, subscription database, and logging databases). The additional data can be retrieved via security management engine data API 170 to support functionality associated with the security management system and more specifically functionality associated with the security risk management engine 110.

The security risk management engine 110 is responsible for communicating with a security management client 130 having the security risk management engine client 132. The security risk management engine client 132 supports client-side security posture management operations for providing security management in the security management system. The security risk management engine client 132 can support requesting a security posture of a computing environment, accessing and presenting a security posture visualization associated with the security posture information, and communicating an indication to perform a recommended remediation action. In this way, security posture information can be communicated between the security risk management engine 110, the security posture management engine 120, and the security management client 130. The security posture management client 130 causes display the security posture information as security posture interface data 134. For example, the security posture interface data 134 can include security posture visualizations generated at the security posture management engine 120 based on security risk management information, as discussed herein.

The security posture management engine 120 operates to provide visibility to security status of resources in a computing environment. Security posture information can be associated with network, data, and identity resources of a computing environment. Security posture information can specifically include security risk management information that prioritizes security issues. The security posture management engine 120 operates with the security management engine data API 122 that provides access to a security graph. The security management engine data can include telemetry data associated with a plurality of resources in a computing environment. In particular, the telemetry data can be security data that is associated with security providers in a computing environment. The security management engine data can include integrated security alerts from different security providers via an API connector that streams alerts.

The security management client 130 can support accessing a security posture visualization and causing display of the security posture visualization. The security management client 130 can include a security incident management client 132 that supports receiving the security incident interface data 134 from the security management system 110A and causing presentation of the security incident interface data 134. The security incident interface data 134 can specifically include security posture visualization associated with security risk management information. The secure posture visualization can further include remediation actions associated different alerts—including alerts that are associated with security risk management information.

The security management client 130 can further support executing a remediation action. In particular, the security posture visualization can include a remediation action for an alert associated with security risk management information. The security management client 130 can receive an indication to perform the remediation action associated with security risk management information. Based on receiving the indication to execute the remediation action, the security management client 130 can communicate the indication to execute the remediation action to cause execution of the remediation action.

With reference to FIG. 1B, FIG. 1B illustrates security risk management engine 110—having contextual security matrix model generator 140 including model generator data 142; contextual security matrix model 150 including security issue data 152, contextual information 154, and security issues tasks 156; security task prioritization engine 160 including primary prioritization operations 162, secondary prioritization operations 164, and refinement operations 166 with refine operations contextual graph 166A; and CSM-based risk score 168A, primary scores 168B, secondary scores 168C, and final secondary scores 168D; and security management client 130 including security risk management engine client 132 and security posture interface data 134.

The contextual security matrix model generator 140 supports generating the contextual security matrix model 150 that processes and analyzes security issues and their corresponding contextual information for representation in a contextual security matrix 158. The contextual security model generator 140 operates to process historical instances of model generator data (e.g., security issues, contextual information, recommended remediation actions, actual remediation actions, outcomes, etc.) to generate the contextual security matrix model 150 that can be used to represent the relationships in model generator data. For example, the contextual security matrix model 150 can include base-scores for different types of security issues and contextual scores for different instances of contextual information for corresponding security. The base-scores and contextual scores can be defined in the contextual security matrix model 150 using the contextual security matrix generator 140 and model generator data 142. The contextual security model 150 can then be used to analyze input data (i.e., security issue data 152, contextual information 154, and security issue tasks 156) to generate the contextual security matrix.

The contextual security matrix 158 defines how each security issue is affected by each instance of contextual information. In particular, the contextual security matrix 158 can be used to represent variables of security issue data 152, contextual information 154, and security issues tasks 156. For example, the security issues can include base-scores, each security issue can be associated with one or more instances of contextual information—with each instance of contextual information having a calculated contextual score for each security issue. Calculating the contextual scores for each instance of contextual information and a corresponding security issue can be performed using the functionality defined in the contextual security matrix model 150 via the contextual security matrix model generator 140. The contextual security matrix 158 also supports representing the different impact of a contextual information on different issues. For example, a first security issue and a second issue may both have a first context; however, the contextual score of the first context for the first security issue can be different than the contextual score of the second context for the second security issue.

The contextual security matrix 158 can be used to generate CSM-based risk scores (e.g., CSM-based risk scores 168A). As discussed, each security issue can be associated with a base-score (e.g., base-score=X), and the issue can be associated with multiple instances of contextual information where the first instance of contextual information has contextual score Y and the second instance of contextual information has contextual score Z. The CSM-based risk score is based on the base-score X, contextual score Y, and contextual score Z. For example, the CSM-based risk score can be generated by: X+Y+Z—where the CSM-based risk score represents an overall risk of the security issue in a computing environment. Other variations and combination of generating CSM-based risk scores based on a base score of a security issue and one or more contextual scores of contexts of the security issue are contemplated with embodiments described herein.

The security task prioritization engine 160 is responsible for prioritizing security tasks (i.e., security issues associated with recommended remediation actions) based on a plurality of security risk management operations. The security risk management operations include primary prioritization operations 162, second prioritization operations 163, and refinement operations 166. The security risk management operations can be performed based in part on a contextual security matrix 158 that is generated based on the contextual security matrix model 150. For example, a plurality of security issues can be processed using the contextual security matrix 152, where the contextual security matrix 152 is further processed via the security task prioritization engine 160 to prioritize the plurality of security issues.

As discussed, the contextual security matrix 158 includes security issues (e.g., security issue data 152) that are can be associated with security issue tasks (e.g., security issue tasks 156). The security issue tasks 156 are actionable items that can be performed to mitigate the security issue. Security issues data 152 can also include a security issue type of a security issue, where the security issue type is a category associated with a security issue to identify, distinguish, and report on security issues.

The security task prioritization engine 160 performs operations to prioritize contextual security issue items (“CSI items”) according to their overall quantified risk. The primary prioritization operations 162 include calculating contextual scores for security issue tasks of a security issue, the contextual scores are calculated using the contextual security matrix (CSM) 158. The highest contextual score (or contextual score and base-score) is identified and designated as a primary score for the security issue. Based on a primary score, the plurality of security issues and their corresponding security issue tasks are grouped into different primary groups. In operation, the primary prioritization operations further include grouping the security issue tasks first by security issue type and then by primary score. The primary groups are subsequently prioritized according to their shared primary score.

The security task prioritization engine 160 further performs operations secondary prioritization operations 164 that include prioritizing security issue tasks 156 within each primary group. The priority groups each have a plurality of security issues and contextual scores and corresponding security issues tasks. The contextual scores can be sorted. In particular, the contextual scores can be sorted in descending order. In this way, the security issue task with the highest un-matching score is prioritized.

The security task prioritization engine 160 can further provide refinement operations 166 and refinement operations contextual graph 166A, for additional fine-tuning secondary scores for prioritizing security issue tasks. For example, a first security issue task and a second security issue task may—via primary prioritization operations 162 and secondary prioritization operations 164 still have the same scores. In such situations, contextual information can be represented as graph nodes and edges. Various contextual information can be represented by different edges in the refinement operations contextual graph. And, for each edge, a decay factor is assigned, representing a quantified difficulty to traverse the edge. For example, a decay factor can be based on historical attack path information and attack path analysis that supports representing a likelihood of a first issue being exploited or a second being exploited as a function of a decay factor.

Each CSI item in the list of contextual issues is compared to its basic form, and for each additional edge, the contextual score is adjusted. In particular, the contextual score can be adjusted by multiplying the contextual score by the edge's decay factor. For example, a basic form of “exposed vulnerable VM has access to resource” is scored X, and account for a single “has access” edge between the VM and the resource. If the access in a CSI item is achieved via a longer path, through an additional node and an additional “has access” edge, then the score is multiplied by the decay factor of the “has access” edge. For example, df*X. The refined contextual scores are then summed to generate a final secondary score (e.g. final secondary scores 160D). Tasks are subsequently prioritized based on the final secondary score. In particular, the final secondary scores can be sorted in descending order.

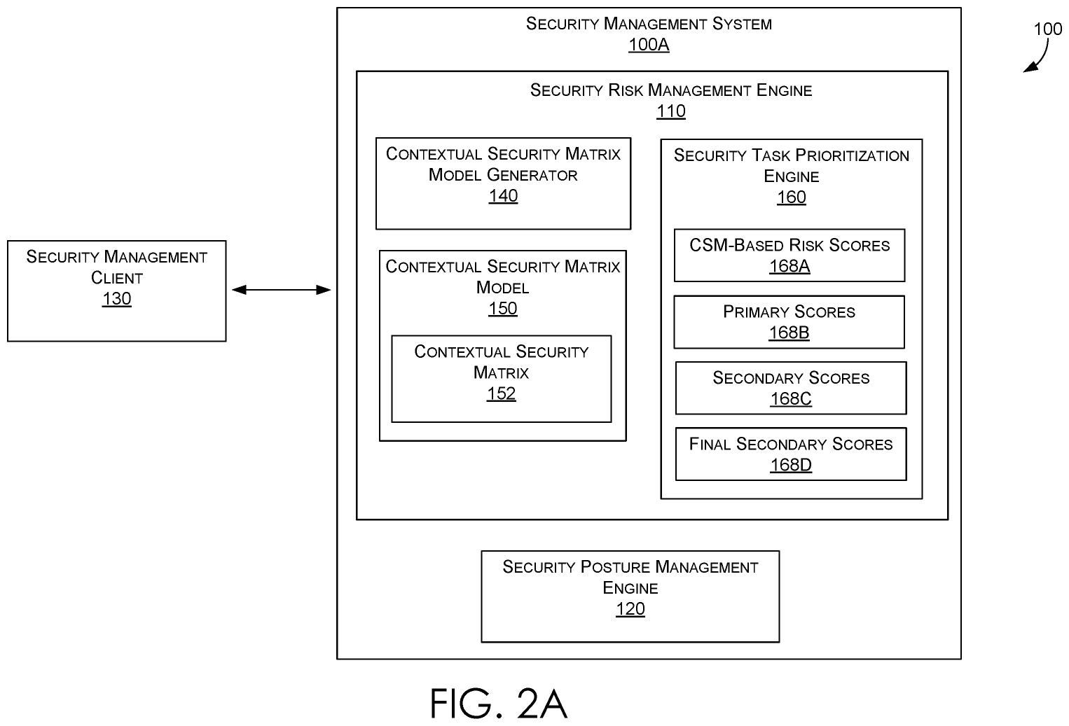

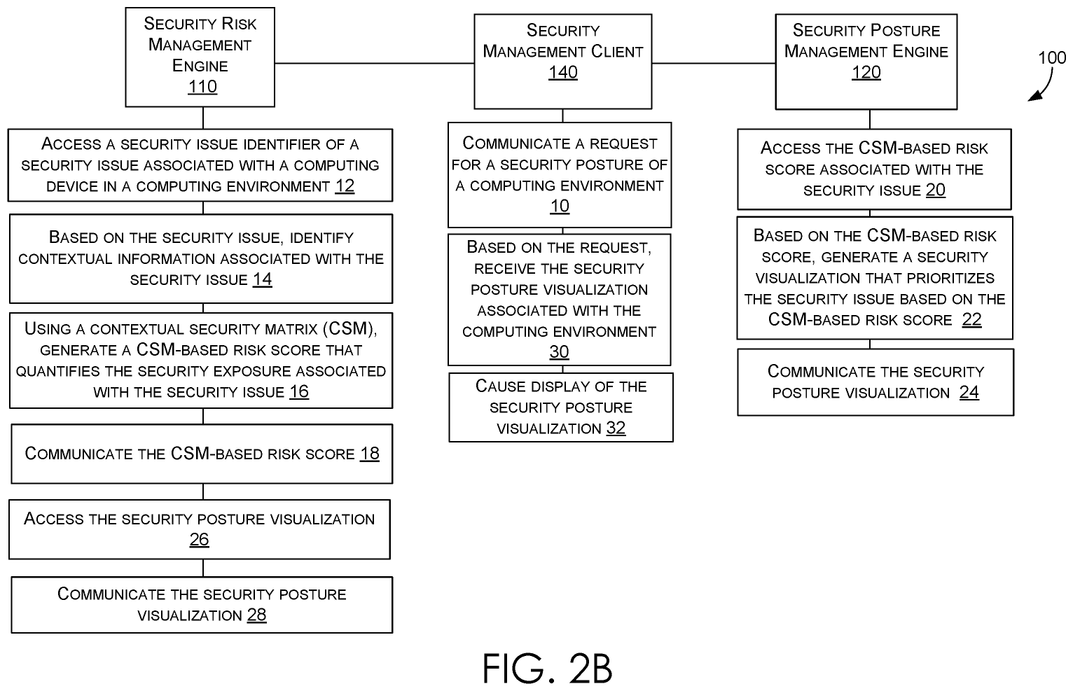

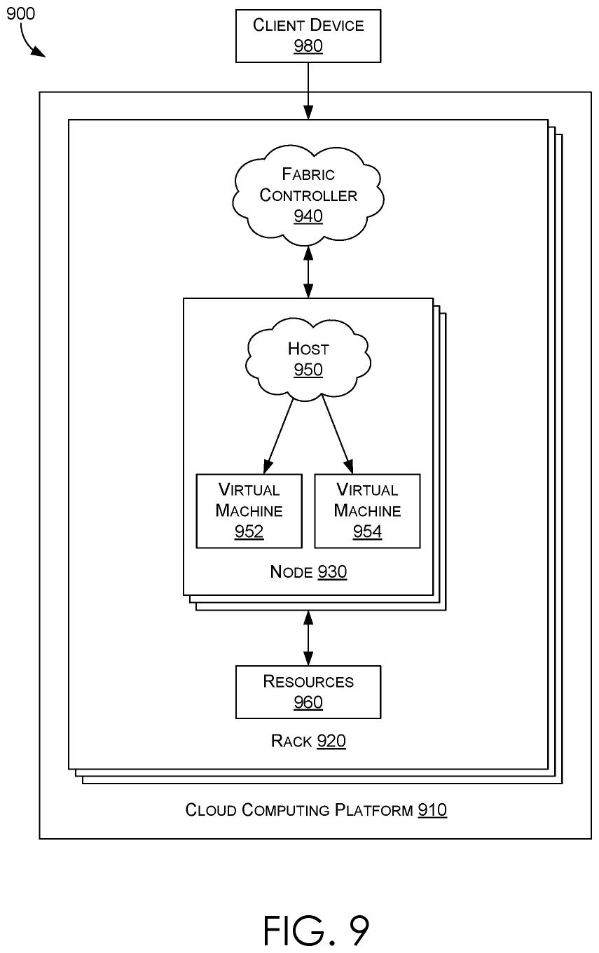

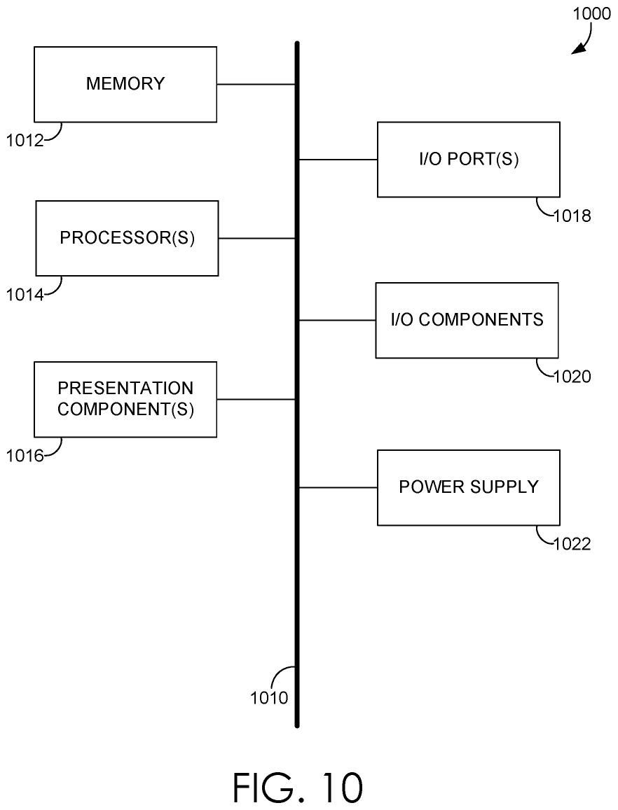

Aspects of the technical solution can be described by way of examples and with reference to FIGS. 2A and 2B. FIG. 2A is a block diagram of an exemplary technical solution environment, based on example environments described with reference to FIGS. 9 and 10 for use in implementing embodiments of the technical solution are shown. Generally the technical solution environment includes a technical solution system suitable for providing the example cloud computing system 100 in which methods of the present disclosure may be employed. In particular, FIG. 2A shows a high level architecture of the cloud computing system 100 in accordance with implementations of the present disclosure. Among other engines, managers, generators, selectors, or components not shown (collectively referred to herein as “components”), the technical solution cloud computing system 100 corresponds to FIG. 1A and 1B.

With reference to FIG. 2A, FIG. 2A illustrates a security management system 100A having security risk management engine 110 including contextual security matrix model generator 140, contextual security matrix model 150, contextual security matrix 152, security task prioritization engine 160 having CSM-based risk scores 168A, primary scores 168B, secondary scores 168C, and final secondary scores 168D; security posture engine management engine 120; and security management client 130.

The security risk management engine 120 is responsible for providing a contextual security matrix 152, context-based security exposure analysis, and prioritization of security issues based on different types of security scores. In particular, the security risk management engine 110 implements the contextual security matrix model generator 140 to generate a contextual security matrix model 150, implements the contextual security matrix model 150 to generate the contextual security matrix 152, and the and security task prioritization engine 160 to generate CSM-based risk scores 168A, primary scores 168B, secondary scores 168C, and final secondary scores 168D.

The security risk management engine 120 accesses a security issue associated with a computing device in a computing environment. Accessing the security issue can include accessing information associated with the security issue including a security issue identifier of the security issue. The security issue identifier can refer to a file identifier or information identifier that is used access and manipulate information associated with security issue. Based on the security issue, contextual information associated with the security issue is identified. The contextual information includes a computing environment configuration or state that affects a security exposure of the security issue on the computing environment. Using the contextual security matrix 152, the security management engine 120 generates a CSM-based risk score that quantifies the security posture exposure associated with the security issue. The contextual security matrix 152 includes a plurality of security issues, a plurality of instances of contextual information, and a plurality of contextual scores, where the contextual security matrix 152 is a scored representation of how each of the plurality of security issues is affected by corresponding contextual information. The contextual security matrix 152 can include one or more recommended remediation actions that are mapped to corresponding security issues. The recommended remediation actions are actionable items that are performed to mitigate security issues in the computing environment.

The contextual security matrix 152 is generated using a contextual security matrix model 152. The contextual security matrix model generator 140 supports generating the contextual security matrix model 152 associated with security issue data, contextual information and security issue tasks (or recommended remediation action data) of the contextual security matrix 152. The contextual security matrix 152 supports generating CSM-based risk scores based on base-scores of security issues and contextual scores of instances of contextual information.

The contextual security matrix 152 can defined a plurality of base-scores that correspond to a plurality of security issues. A base-score can be a predefined score of a security issue. The contextual security matrix 152 can further define instances of contextual information that each have a contextual score, where the contextual score is based on a corresponding issues associated with the contextual information. In this way, a contextual score can be associated with an instance of contextual information, where the contextual score is a quantified additional security exposure of the security issue based on the instance of contextual information. The additional security exposure can be associated with a potential impact or a potential exploitability of the security issue.

The security posture management engine 120 uses CSM-based risk scores 168A to generate a security posture visualization associated with the computing environment. The security posture visualization includes the security issue (e.g., security issue identifier) associated with the CSM-based risk scores 168A. The security posture management engine 120 communicates the security posture visualization to the security management client 130 to cause display of the security posture visualization. The security posture visualization can include each of a plurality of security issues as alerts, wherein an alert comprises a prioritization identifier and a recommended remediation action. The recommended remediation action is executable to address a security threat associated with the alert.

With reference to FIG. 2B, FIG. 2B illustrates a software development environment having security risk management engine 110, security management client 130, and security posture management engine 150. At block 10, the security management client 130 communicates a request for a security posture of a computing environment. At block 12, the security risk management engine accesses a security issue identifier of a security issue associated with a computing device in a computing environment; and at block 14, based on the security issue, identifies contextual information associated with the security issue. At block 16, the security risk management engine 110 uses a contextual security matrix (CSM) to generate a CSM-based risk score that quantifies the security exposure associated with the security issue; and at block 18 communicates the CSM-based risk score. At block 20, the security posture management engine 150 accesses the CSM-based risk score associated with the security issue; and at block 22, based on the CSM-based risk score, generates a security visualization that prioritizes the security issue based on the CSM-based risk score. At block 24, the security posture management engine, communicates the security posture visualization. At block 26, the security risk management engine 110 accesses the security posture visualization; and at block 28, communicates the security posture visualization. At block 30, the security management client 130, based on the request for the security posture of the computing environment, receives a security posture visualization associated with the computing environment. And, at block 32, the security management client 130 causes display of the security posture visualization.

### Example Methods

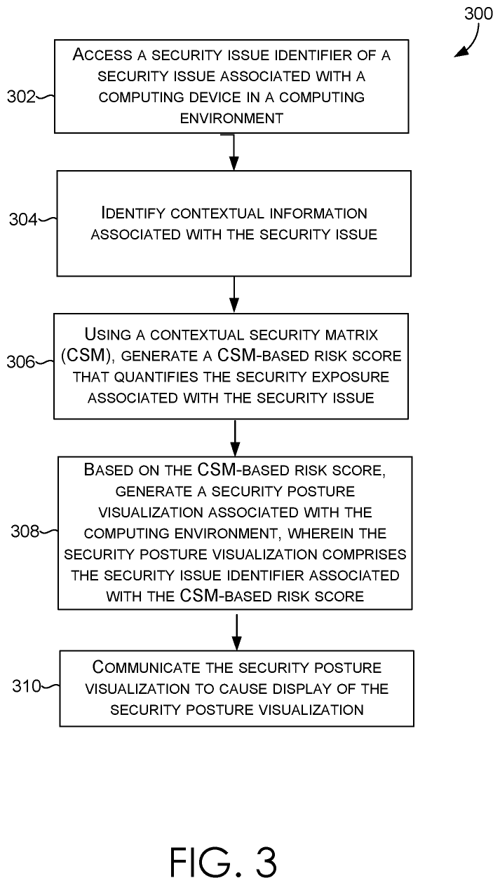

With reference to FIGS. 3-8, flow diagrams are provided illustrating methods for providing security risk management using a security risk management engine in a security management system. The methods may be performed using the security management system described herein. In embodiments, one or more computer-storage media having computer-executable or computer-useable instructions embodied thereon that, when executed, by one or more processors can cause the one or more processors to perform the methods (e.g., computer-implemented method) in the security management system (e.g., a computerized system or computing system).

Turning to FIG. 3, a flow diagram is provided that illustrates a method 300 for providing security risk management using a security risk management engine in a security management system. At block 302, a security issue identifier of a security issue associated with a computing device in a computing environment is accessed. At block 304, Contextual information associated with the security issue is accessed. At block 306, using a contextual security matrix (CSM), a CSM-based risk score that quantifies the security exposure associated with the security issue is generated. At block 308, based on the CSM-based risk score, a security risk posture visualization associated with the computing environment is generated. The security posture visualization comprises the security issue identifier associated with the CSM-based risk score. At block 310, the security posture visualization is communicated to cause display of the security posture visualization.

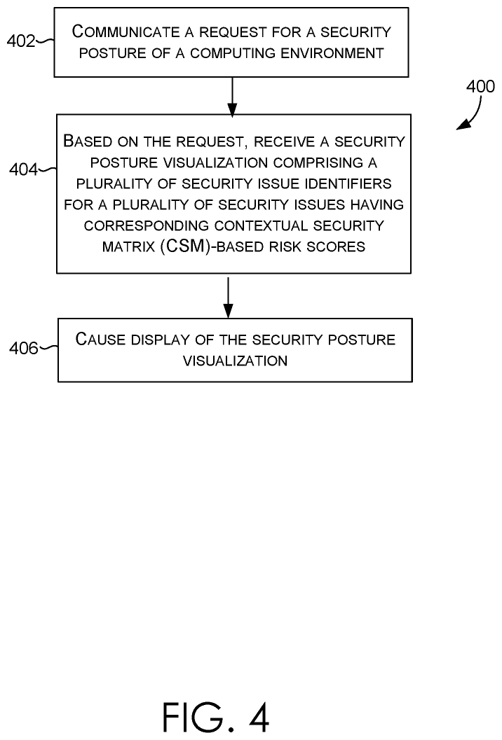

Turning to FIG. 4, a flow diagram is provided that illustrates a method 400 for providing security risk management using a security risk management engine in a security management system. At block 402, a request for a security posture of a computing environment is communicated. At block 404, based on the request, a security posture visualization comprising a plurality of security issue identifiers for a plurality of security issues having corresponding contextual security matrix (CSM)-based risk scores is received. At block 406, the security posture visualization is caused to be displayed.

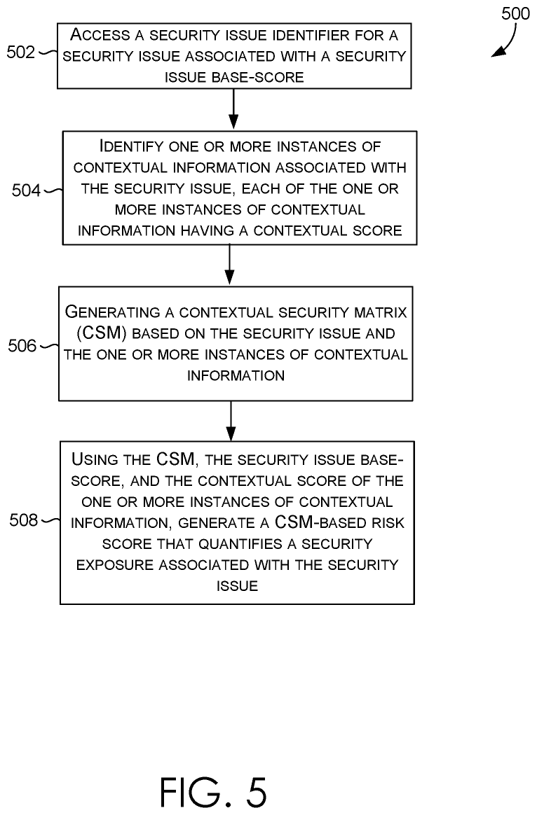

Turning to FIG. 5, a flow diagram is provided that illustrates a method 500 for providing security risk management using a security risk management engine in a security management system. At block 502, a security issue identifier for a security issue associated with a security issue base-score is accessed. At block 504, one or more instances of contextual information associated with the security issue are identified. Each of the one or more instances of contextual information having a contextual score. At block 506, a contextual security matrix (CSM) is generated based on the security issue and the one or more instances of contextual information. At block 508, using the CSM, the security issue base-score, and the contextual score of the one or more instances of contextual information, a CSM-based risk score that quantifies a security risk exposure associated with the security issue is generated.

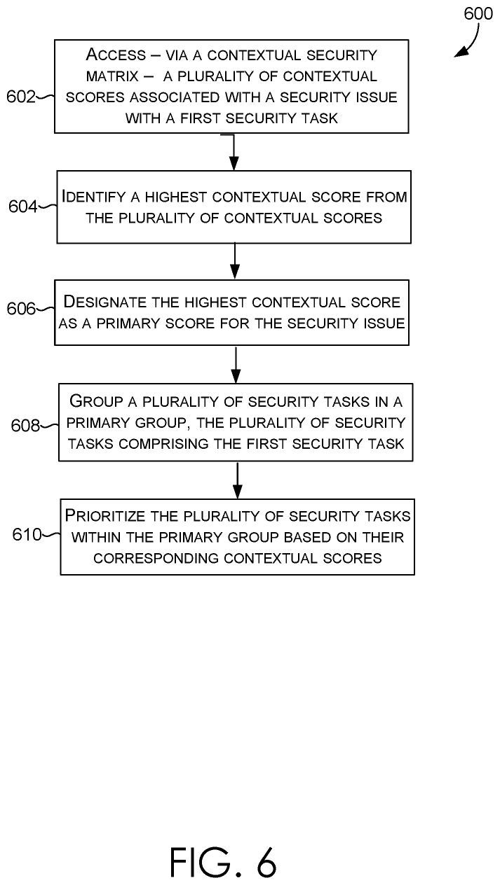

Turning to FIG. 6, a flow diagram is provided that illustrates a method 600 for providing security risk management using a security risk management engine in a security management system. At block 602, a plurality of contextual scores associated with a security issue having a first security task are accessed via a contextual security matrix. At block 604, a highest contextual score is identified from the plurality of contextual scores. At block 606, the highest contextual score is designated a primary score for the security issue. At block 608, a plurality of security tasks for a plurality of security issues are grouped in a primary group. The plurality of security tasks include the first security tasks of the security issue. At block 610, the plurality of security tasks within the primary group are prioritized based on their corresponding contextual scores.

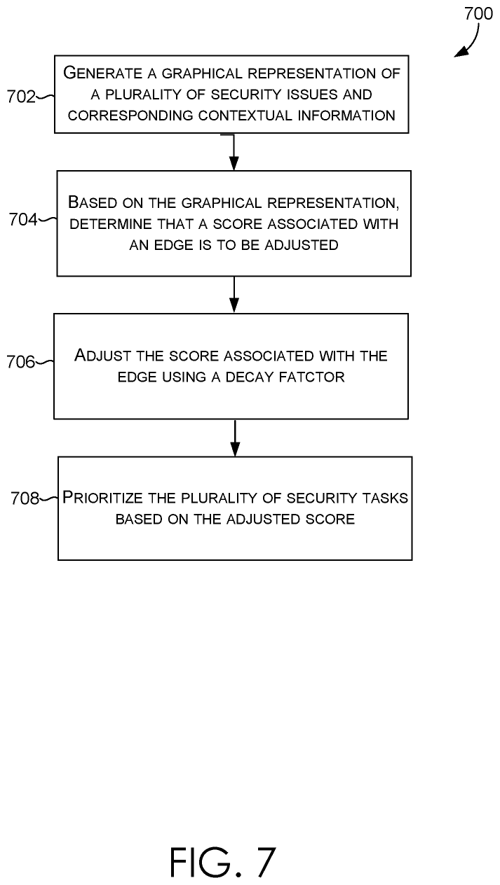

Turning to FIG. 7, a flow diagram is provided that illustrates a method 700 for providing security risk management using a security risk management engine in a security management system. At block 702, a graphical representation of a plurality of security issues and corresponding contextual information is generated. The plurality of security issues each having a corresponding security issue task in a plurality of security issue tasks. The graphical representation includes edges and nodes associated with contextual information and contextual scores associated with the plurality of security tasks. At block 704, based on the graphical representation, a determination is made that a score associated with an edge is to be adjusted. At block 706, the score associated with the edge is adjusted using a decay factor. At block 708, the plurality of security tasks are prioritized based on the adjusted score.

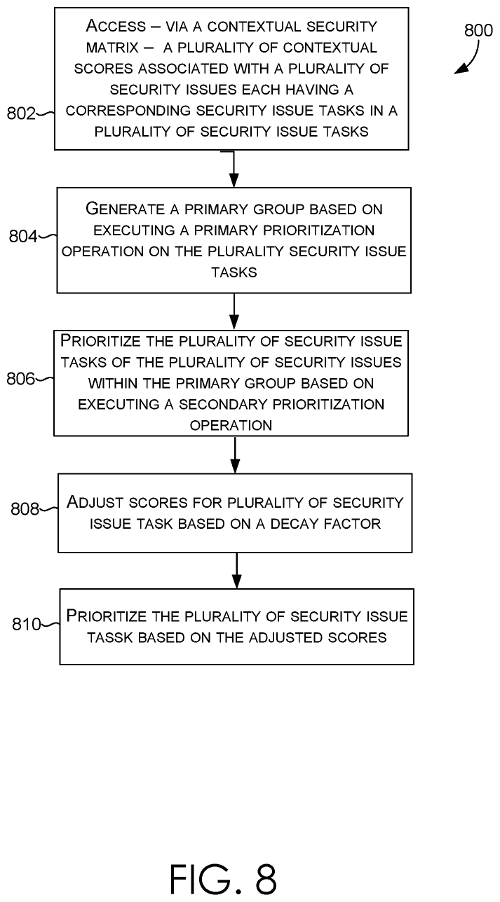

Turning to FIG. 8, a flow diagram is provided that illustrates a method 800 for providing security risk management using a security risk management engine in a security management system. At block 802, a plurality of contextual scores associated with a plurality of security issues are accessed. Each of the plurality of contextual scores is associated with a plurality of security issues each having corresponding security issue tasks in a plurality of security issue tasks. At block 804, a primary group is generated based on executing a primary prioritization operation on the plurality of security issue tasks. At block 806, a plurality of security issue tasks of the plurality of security issues within the primary group are prioritized based on executing a secondary prioritization operation. At block 808, the scores are adjusted for the plurality security issues tasks based on a decay factor. At block 810, the plurality of security issue tasks are adjusted based on the adjusted scores.

### Technical Improvement

Advantageously, the embodiments of the present technical solution include several inventive features (e.g., operations, systems, engines, and components) associated with a security management system having the security risk management engine. Inventive features will be described with reference to operations for providing security posture information using a security risk management engine in a security management system. Functionality of the embodiments of the present technical solution will further be described, by way of an implementation and anecdotal examples, to demonstrate that the security risk management operations—(e.g., providing a contextual security matrix, context-based security exposure analysis, and prioritization of security issues based on a plurality security scores)—are a solution to a specific problem in a software development environment to improve computing operations and interface for security management systems. For example, the operations provide an improved user interface that summarizes and presents security posture information—associated with contextual information of security issues—in a particular manner to facilitate security posture management. Overall, these improvements result in less CPU computation, smaller memory requirements, and increased flexibility in security management systems.

### Additional Support for Detailed Description

### Example Distributed Computing System Environment

Referring now to FIG. 9, FIG. 9 illustrates an example distributed computing environment 900 in which implementations of the present disclosure may be employed. In particular, FIG. 9 shows a high level architecture of an example cloud computing platform 910 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 900 that includes cloud computing platform 910, rack 920, and node 930 (e.g., computing devices, processing units, or blades) in rack 920. The technical solution environment can be implemented with cloud computing platform 910 that runs cloud services across different data centers and geographic regions. Cloud computing platform 910 can implement fabric controller 940 component for provisioning and managing resource allocation, deployment, upgrade, and management of cloud services. Typically, cloud computing platform 910 acts to store data or run service applications in a distributed manner. Cloud computing infrastructure 910 in a data center can be configured to host and support operation of endpoints of a particular service application. Cloud computing infrastructure 910 may be a public cloud, a private cloud, or a dedicated cloud.

Node 930 can be provisioned with host 950 (e.g., operating system or runtime environment) running a defined software stack on node 930. Node 930 can also be configured to perform specialized functionality (e.g., compute nodes or storage nodes) within cloud computing platform 910. Node 930 is allocated to run one or more portions of a service application of a tenant. A tenant can refer to a customer utilizing resources of cloud computing platform 910. Service application components of cloud computing platform 910 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 930, nodes 930 may be partitioned into virtual machines (e.g., virtual machine 952 and virtual machine 954). Physical machines can also concurrently run separate service applications. The virtual machines or physical machines can be configured as individualized computing environments that are supported by resources 960 (e.g., hardware resources and software resources) in cloud computing platform 910. It is contemplated that resources can be configured for specific service applications. Further, each service application may be divided into functional portions such that each functional portion is able to run on a separate virtual machine. In cloud computing platform 910, multiple servers may be used to run service applications and perform data storage operations in a cluster. In particular, the servers may perform data operations independently but exposed as a single device referred to as a cluster. Each server in the cluster can be implemented as a node.

Client device 980 may be linked to a service application in cloud computing platform 910. Client device 980 may be any type of computing device, which may correspond to computing device 900 described with reference to FIG. 9, for example, client device 980 can be configured to issue commands to cloud computing platform 910. In embodiments, client device 980 may communicate with service applications through a virtual Internet Protocol (IP) and load balancer or other means that direct communication requests to designated endpoints in cloud computing platform 910. The components of cloud computing platform 910 may communicate with each other over a network (not shown), which may include, without limitation, one or more local area networks (LANs) and/or wide area networks (WANs).

### Example Computing Environment

Having briefly described an overview of embodiments of the present technical solution, an example operating environment in which embodiments of the present technical solution may be implemented is described below in order to provide a general context for various aspects of the present technical solution. Referring initially to FIG. 9 in particular, an example operating environment for implementing embodiments of the present technical solution is shown and designated generally as computing device 900. Computing device 900 is but one example of a suitable computing environment and is not intended to suggest any limitation as to the scope of use or functionality of the technical solution. Neither should computing device 1000 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 10, computing device 1000 includes bus 1010 that directly or indirectly couples the following devices: memory 1012, one or more processors 1014, one or more presentation components 1016, input/output ports 1018, input/output components 1020, and illustrative power supply 1022. Bus 1010 represents what may be one or more buses (such as an address bus, data bus, or combination thereof). The various blocks of FIG. 10 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 10 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer storage media in the form of volatile and/or nonvolatile memory. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc. Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing a security issue associated with a computing device in a computing environment;
identifying contextual information associated with the security issue, wherein the contextual information comprises a computing environment configuration or state that affects a security exposure of the security issue on the computing environment;
using a contextual security matrix (CSM), generating a CSM-based risk score that quantifies the security exposure associated with the security issue, wherein a CSM model supports generating the CSM that is associated with CSM-based risk scores, security issue base-scores of security issues, and contextual scores of instances of contextual information
based on the CSM-based risk score, generating a security posture visualization associated with the computing environment, wherein the security posture visualization comprises the security issue associated with the CSM-based risk score; and
communicating the security posture visualization to cause display of the security posture visualization.

2. The system of claim 1, wherein a contextual security matrix model generator is, associated with a security risk management engine, supports generating the contextual security matrix model associated with security issue data, contextual information, and recommended remediation action data of the CSM.

3. The system of claim 1, wherein the CSM further comprises a plurality of security issues, a plurality of instances of contextual information, and a plurality of contextual scores, wherein the CSM is a scored representation of how each of the plurality of security issues is affected by corresponding contextual information.

4. The system of claim 1, wherein the CSM further comprises one or more recommended remediation actions that are mapped to the security issue, wherein a recommended remediation action is an actionable item that is performed to mitigate the security issue in the computing environment.

5. The system of claim 1, wherein a base-score of the security issue is a predefined score of the security issue and a contextual score of an instance of contextual information is a quantified additional security exposure of the security issue based on the instance of contextual information, wherein the quantified additional security exposure is associated with a potential impact or a potential exploitability.

6. The system of claim 1, wherein the security issue is associated with a first instance of contextual information and a second instance of contextual information, the first instance of contextual information is associated with a first contextual score and the second instance of contextual information is associated with a second contextual score.

7. The system of claim 1, wherein the CSM-based risk score is generated based on a sum of a security base-score of the security issue and a contextual score of one or more instances of contextual information of the security issue.

8. The system of claim 1, wherein a security posture management engine supports generating a security posture visualization comprising a plurality of security issues, wherein the plurality security issues are associated with corresponding CSM-based risk scores and contextual information, wherein the security posture visualization comprises each of the plurality of security issues as alerts, wherein an alert comprises a prioritization identifier and a recommended remediation action, wherein the recommended remediation action is executable to address a security threat associated with the alert. 9 The system of claim 1, the operations further comprising:
communicating, from a security management client, a request for a security posture of the computing environment;
based on the request, receiving the security posture visualization associated with the computing environment, wherein the security posture visualization comprises an alert associated with the computing device, the security issue, and an instance of contextual information associated with security issue; and
causing display of the security posture visualization.

10. The system of claim 1, the operations further comprising:
receiving an indication to execute a remediation action associated with the security issue, wherein the recommended remediation action is associated with the security posture visualization; and
communicating the indication to execute the remediation action to cause execution of the recommended remediation action.

11. One or more computer-storage media having computer-executable instructions embodied thereon that, when executed by a computing system having a processor and memory, cause the processor to perform operations, the operations comprising:
communicating a request for a security posture of a computing environment;
based on the request, receiving a security posture visualization associated with the computing environment, wherein the security posture visualization comprises a plurality of security issues having corresponding contextual security matrix (CSM)-based risk scores, wherein a CSM-based risk score quantifies a security exposure associated with a security issue, wherein the CSM-based risk score is generated using a CSM,
wherein a CSM model supports generating the CSM that is associated with CSM-based risk scores, security issue base-scores of security issues, and contextual scores of instances of contextual information; and
causing display of the security posture visualization.

12. The media of claim 11, wherein the CSM further comprises a plurality of security issues, a plurality of instances of contextual information, and a plurality of contextual scores, wherein the CSM is a scored representation of how each of the plurality of security issues are affected by corresponding contextual information.

13. The media of claim 11, wherein the CSM further comprises one or more recommended remediation actions that are mapped to the security issue, wherein a recommended remediation actions is an actionable item that is performed to mitigate the security issue in the computing environment.

14. The media of claim 11, wherein the security posture visualization comprises a plurality of security issues, wherein the plurality security issues are associated with corresponding CSM-based risk scores and contextual information.

15. The media of claim 11, the operations further comprising:
receiving an indication to execute a remediation action associated with the security issue, wherein the recommended remediation action is associated with the security posture visualization; and
communicating the indication to execute the remediation action to cause execution of the recommended remediation action.

16. A computer-implemented method, the method comprising:
accessing a security issue associated with a computing device in a computing environment;
generating a security posture visualization associated with the computing environment, wherein the security posture visualization comprises the security issue associated with a contextual security matrix (CSM)-based risk score that is generated using a CSM,
wherein a CSM model supports generating the CSM that is associated with CSM-based risk scores, security issue base-scores of security issues, and contextual scores of instances of contextual information; and
communicating the security posture visualization to cause display of the security posture visualization.

17. The method of claim 16, wherein the CSM further comprises one or more recommended remediation actions that are mapped to the security issue, wherein a recommended remediation actions is an actionable item that is performed to mitigate the security issue in the computing environment.

18. The method of claim 16, wherein the security posture visualization comprises a plurality of security issues as alerts, wherein an alert comprises a prioritization identifier and a recommended remediation action, wherein the recommended remediation action is executable to address a security threat associated with the alert.

19. The method of claim 16, wherein the security issue is associated with a first instance of contextual information and a second instance of contextual information, the first instance of contextual information is associated with a first contextual score and the second instance of contextual information is associated with a second contextual score.

20. The method of claim 16, the method further comprising:
receiving an indication to execute a remediation action associated with the security issue, wherein the recommended remediation action is associated with the security posture visualization; and
communicating the indication to execute the remediation action to cause execution of the recommended remediation action.
